(19) United States
(12) Patent Application Publication
(10) Pub. No.: US 2006/0129418 A1
(43) Pub. Date: Jun. 15, 2006

(54) Method and apparatus for analyzing functionality and test paths of product line using a priority graph

(75) Inventors: Jihyun Lee, Taejon (KR); Jin Hee Cho, Taejon (KR); Dong Han Ham, Taejon (KR); Jin Sam Kim, Taejon (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/085,175

(22) Filed: Mar. 22, 2005

(30) Foreign Application Priority Data
Dec. 15, 2004 (KR) 2004-106612

(51) Int. Cl. G06F 9/44

(52) U.S. Cl. 705/1; 717/120

(57) ABSTRACT

The present invention relates to a method and apparatus for analyzing functionality and test paths of product line using a priority graph. The apparatus includes: a parser for analyzing a use case scenario expressed in a text format, in a unit of word to separate a word from the analyzed use case scenario; an object/behavior identifier for extracting core noun and verb from the separated word; a dependency graph modeler for supporting to model an execution flow of a function; a priority graph editor for supporting to analyze and express linked feature objects, a feature category, a default value, a reference value, a use case name, variation points; a test path identifier for identifying a test path to examine requirements and plan a test at an information expression of a priority graph; and a graphic information processor for visually changing and showing an analysis information of the dependency graph and the priority graph.

### BACKGROUND OF THE INVENTION

1. Field of the Invention

The present invention relates to a method and apparatus for analyzing functionality and test paths of product line using a priority graph, and more particularly, to a method and apparatus for analyzing functionality and test paths of product line using a priority graph that identifies the variability of a product line on the basis of the commonality, in which an upper-level business process is modeled using a use case scenario, and a commonality and a variability for analyzing a product line are identified.

2. Description of the Related Art

In a general software engineering, as computer-Aided Software Engineering (CASE) tools, the latest tools are related to component-based modeling, or decomposing a structural element for a target system into a sub-system, a component, a class and a function to reflect requirements on the models. Therefore, the requirements have been acquired in a way in which of describing brainstorm contents, depicting a fishbone diagram and a use case diagram, or editing a vision descriptive document.

Prior paper “Holmes: An Intelligent System to Support Software Product Line Development” is disclosed in 2001 to support the acquiring of the requirements. In the paper, a tool support is emphasized for interdependent actions that should be performed for a product line development. Most of tools put emphasis only on the development of a component. Accordingly, in the prior paper, a lower structure associated with external tools for the product line development is provided, and the external tools are integrated depending on the lower structure to analyze and model a product line. Unitary tools such as “Rational Rose 2002” and “WebMetrics Rose Parser” bring into use for a tool integration to allow a Unified Modeling Language (UML)-based design. However, since the Holmes provides a very loosely related architecture to manage data of several tools, it should consistently express and associate a data model. Additionally, the Holmes has a disadvantage in that a cost should be paid for the external tool.

In the prior patent “Method for Analyzing Product Information”, a single inherent database is used separately from the conventional UML-based modeling tool to store and manage various product analysis information, thereby allowing various user's accesses, and a visual analyzer is used to visually express requirements information. Additionally, the stored requirements can be queried to allow several sources to alternatively access to inputted data. However, the prior patent has a drawback in that system, method, quality data inputted from several data sources are unsatisfactory as product analysis information for producing a product line-based product because they are just only visually analyzed without the consideration of a meaningful relation and a variable characteristic.

Accordingly, an apparatus and method is being required for verifying the functional requirements of the variously analyzed product, and more easily analyzing and verifying a meaningful commonality and variability of the product line requirements.

### SUMMARY OF THE INVENTION

Accordingly, the present invention is directed to a method and apparatus for analyzing functionality and a test path of a product line using a priority graph, which substantially obviates one or more problems due to limitations and disadvantages of the related art.

It is an object of the present invention to provide a method and apparatus for analyzing functionality and test paths of product line using a priority graph, in which in steps of designing, implementing and testing, core object and behavior are identified from the requirements based on a product line, and scopes of the identified object and behavior are adjusted to analyze a feature object, a variability of the feature object, behavior information of the feature object and their mutual dependencies, which are essential for a function execution of the requirements.

The present invention defines a process of a function provided from a system on the basis of upper-level meaning information of the requirements. There has been a disadvantage in that product development participants should be previously fully aware of a business standard such as a Unified Modeling Language (UML) extension specification since research participants for the production of the product line based-product should have the same understanding for the production, and an analysis is performed depending on a notation and a tool following the UML extension specification. However, the present invention has an effect in that an analysis and examination tool is characterized by a method of simply and conveniently expressing and analyzing product requirements in a field where a short life cycle is repeatedly performed, such as the product line.

Starting from a hardware and software function of a level, which is known to the research participants, the inventive dependency graph supports to analyze the feature object, the variability of the feature object, a relation between the feature objects and behavior information, which are essential for the product line based-product. In the dependency graph complicated due to a repetitive analysis process, a sequence of function to execute can be identified. And the dependency graph is expressed into the priority graph constituted of items essential for the product line analysis. In the priority graph, a scope of the product line is separated, modeled and examined at each of use cases through a refining process. An execution sequence of the priority graph is effective in identifying the test path, and the analysis information expressed using the priority graph can be transformed into a table format and inquired, thereby facilitating examination.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus for analyzing functionality and test paths of product line using a priority graph, the apparatus including: a parser for analyzing a use case scenario expressed in a text format, in a unit of word to separate each word from the analyzed use case scenario; an object/behavior identifier for extracting core noun and verb from the separated word, to identify the extracted noun and verb as a feature object name and a feature behavior name; a dependency graph modeler for supporting to model an execution flow of a function, which is expressed in the use case scenario using the feature object name and the feature behavior name; a priority graph editor for supporting to analyze and express for a next execution, linked feature objects, a feature category, a default value, a reference value, a use case name, variation points which should be supported and a type of the variation point at each of feature objects identified by repetitively refining a meaning information of a dependency graph; a test path identifier for identifying a test path to examine requirements and plan a test at an information expression of a priority graph; and a graphic information processor for visually changing and showing an analysis information of the dependency graph and the priority graph.

In another aspect of the present invention, there is provided a method for analyzing functionality and test paths of product line using a priority graph, the method including: a step of describing an upper-level business process in a text format to change the described business process into a use case scenario specification; a step of separating a noun and a verb in a unit of sentence from the text-formatted use case scenario specification; a step of extracting essential noun and verb for the execution of a function, which is expressed in a use case scenario; a dependency graph modeling step of modeling a feature object name and a feature behavior name being inherent attributes, as a node and an edge, on the basis of a function execution dependency specified in the use case scenario; a dependency graph refining step of analyzing while refining additional information such as a linked feature object list, a category of a feature object, a default value, a reference value, a use case name, a supporting variation point list and a type of variation point, at a function execution path by using a dependency graph; a priority graph-modeling step of expressing the analysis information using the priority graph; a priority graph refining step of checking and refining a path flow in the priority graph; a visual information processing step of changing and visually showing an information expression way of the analyzed priority graph; a step of editing a requirements analysis as a work product when the editing is requested; a step of identifying a path necessary for the test in the priority graph; and a step of editing a test plan when the editing is requested.

The present invention mainly has four peculiarities.

First, product line requirements of a text format are received as a use case scenario of the text format to identify a name of the object and a name of the behavior relating the functionality of the product.

Second, the present invention supports to model a dependency of the identified object and behavior depending on an execution flow by using the dependency graph.

Third, the objects identified by repetitively refining the created dependency graph are decomposed or grouped to be defined as feature objects representing a meaningfully indecomposable feature, and express a feature category and a value of the feature object additionally extracted. The behavior for the feature object is performed to reach the node. The objects functioning as execution subjects in a next sequence are expressed as a linked feature object list to represent an execution priority. The objects support to edit the priority graph together with a use case name and a variability list affecting a feature.

Last, the present invention supports to identify a use case-test path, a feature object-test path, a best case-test path and a worst case-test path in the priority graph, which is expressed on the basis of the priority of a sequence object in the next execution.

For this, the present invention provides six additional units of a parser, an object/behavior identifier, a dependency graph modeler, a priority graph editor, a test path identifier and a graphic information processor. This is in detail described as below.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a flowchart illustrating a system execution method according to the present invention;

FIG. 2 is a view illustrating an upper-level function specification;

FIG. 3 is a view illustrating a use case scenario;

FIG. 4 is a view illustrating a construction of a system according to the present invention;

FIG. 5 is a view illustrating an example of a structure of a dependency graph;

FIG. 6 is a view illustrating an example of a structure of a priority graph using a view of a table format; and

FIG. 7 is a view illustrating an example of a structure of a use case-variability definition graph using a view of a table format.

### DETAILED DESCRIPTION OF THE INVENTION

Reference will now be made in detail to the preferred embodiments of the present invention, examples of which are illustrated in the accompanying drawings.

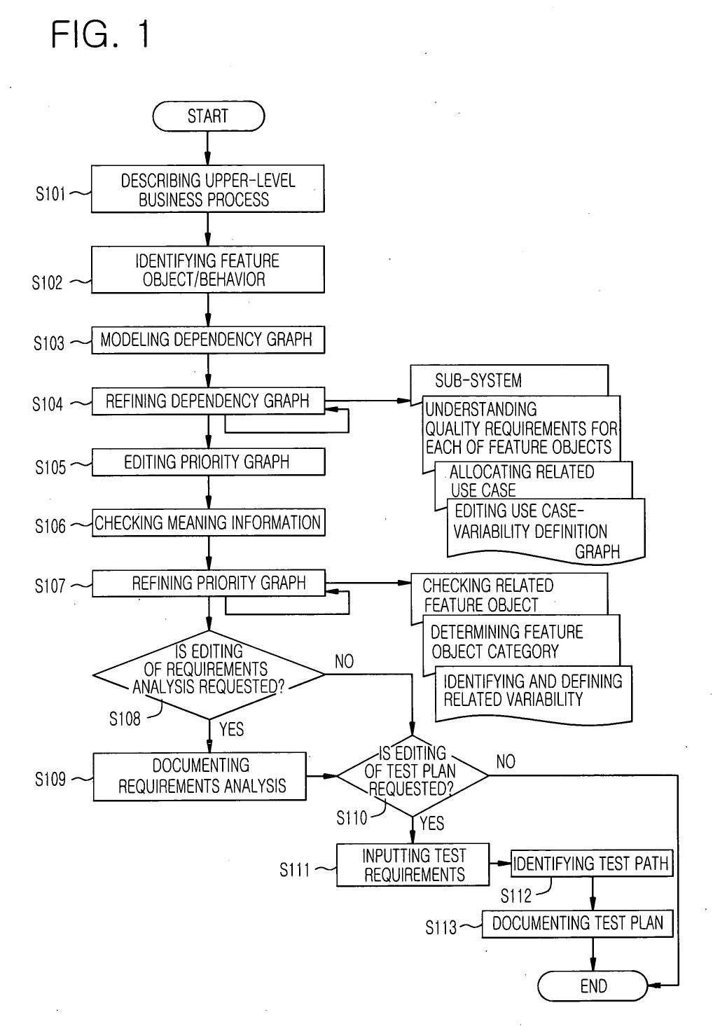

FIG. 1 is a flowchart illustrating a system execution flow according to the present invention.

Referring to FIG. 1, a system user is requested to describe upper level business processes in text formats. Initially, the processes are described in the text formats irrespective of format, and then the text format of the process is changed into a user case scenario format to complementarily describe requirements of each of items (S101).

An object name and a behavior name are identified from the use case scenario of the text format. The object and behavior names expressing independent meaning information are defined as a feature object and a feature behavior being a unit expressing a system feature (S102).

Functional dependencies of the feature object and the feature behavior are expressed in a graph. In the graph, the feature object is expressed as a node, and the feature behavior is expressed as an edge to model the dependency graph (S103).

Upper-level analysis information expressed using the dependency graph is examined and refined (S104).

On the basis of the dependency graph, a possibility of a variable usage of the feature object is defined as a variation point, and the feature objects to be performed in the next of a current feature object are defined as a linked feature object list depending on the execution priority (S105).

It is confirmed together whether or not the feature object, the feature behavior, the linked feature object list, the feature category, a default value of the feature object, a reference value being changed during the execution, a corresponding use case name, a variation point list of the object, and a type of a variation point, which are marked on the priority graph, are meaningfully consistent (S106).

A revised item or an extended portion of functional requirements of a system analyzed in the S106 is analyzed and is repetitively refined to extract common requirements (S107).

It is checked whether or not requirements analysis information needs to be described in a document (S108).

In case where the creation of a document about requirements analysis is requested, information of the priority graph is described in the text format for good reading, to create a document about the requirement analysis as a work product (S109).

It is checked whether or not the edition of a test plan is requested (S110).

The requirements necessary for the test are requested and inputted depending on the request for the edition of the test plan (S111).

A test case is identified on the basis of an execution path of the priority graph and the test requirements inputted in the S111 (S112).

The test plan of the document format is created as the work production (S113).

The upper-level business process should be described to include the item constituting the use case scenario so that the object and behavior names can be identified.

The dependency graph should be constituted of the core object and behavior names, which cannot be meaningfully divided.

The modeling of the dependency graph-refining step supports the modeling for a sub-system, and leads to understand quality requirements requested from each of feature objects. The use case is allotted in this step. If use case edition is possible, an initial edition model of a use case-variability definition graph should be expressed.

In the priority graph, the linked feature object list should be specified to notify the next object to be executed. However, in case where the setting of the feature category is expressed as Default (D), the sequence of the feature object specified in the linked feature object list becomes the execution sequence. In case where the feature category is Alternative (A), the linked feature object is set not to have a priority.

In the priority graph-refining step, the linked feature object list necessary for the next execution should be identified, and the category of the feature object should be decided. Further, the variability should be identified and defined at each of related feature objects.

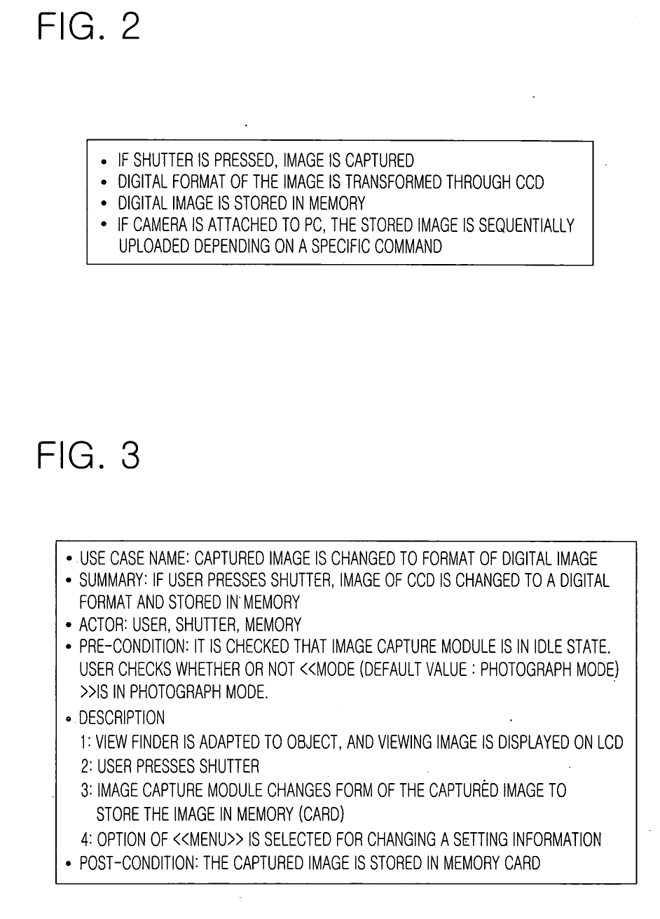

FIG. 2 is a view illustrating an upper-level function specification. In detail, FIG. 2 illustrates an exemplary case in which an image is captured using a digital camera.

FIG. 3 is a view illustrating the use case scenario. In detail, FIG. 3 illustrates an exemplary case in which the image is captured from the digital camera.

Referring to FIG. 3, upper-level information described in the text format is changed to a use case scenario format. The use case name, a summary, an actor in charge, a pre-condition, an execution step and a post-condition are expressed.

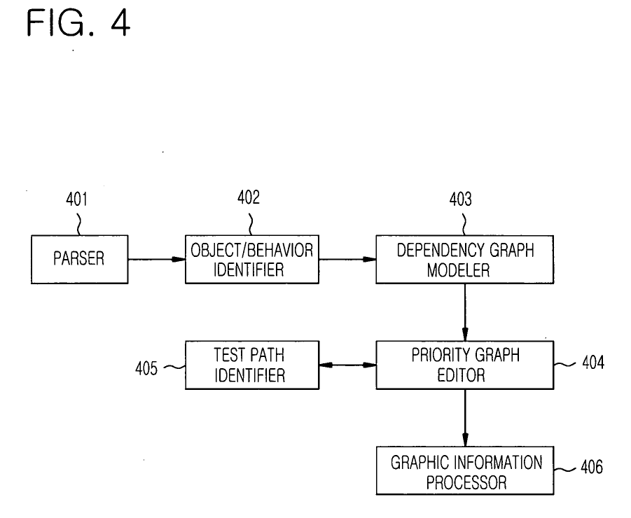

FIG. 4 is a view illustrating a construction of the system according to the present invention.

Referring to FIG. 4, the inventive apparatus for analyzing the functionality and the test path of the product line using the priority graph mainly includes a parser 401, an object/behavior identifier 402, a dependency graph modeler 403, a priority graph editor 404, a test path identifier 405, and a graphic information processor 406.

The parser 401 parses the text-format requirements, which is expressed using the use case scenario, to separate the parsed requirements in a unit of word.

The object/behavior identifier 402 extracts core noun and verb from the separated word to identify the extracted noun and verb as the feature object name and the feature behavior name.

The dependency graph modeler 403 supports a modeling function to express a function execution flow, that is, an interaction as the identified feature object name and feature behavior name. The feature object is expressed as the node, and the feature behavior is expressed as the edge, which has the behavior name as a label. The modeling of the dependency graph is expressed as the graph completely modeled depending on a user's judgment.

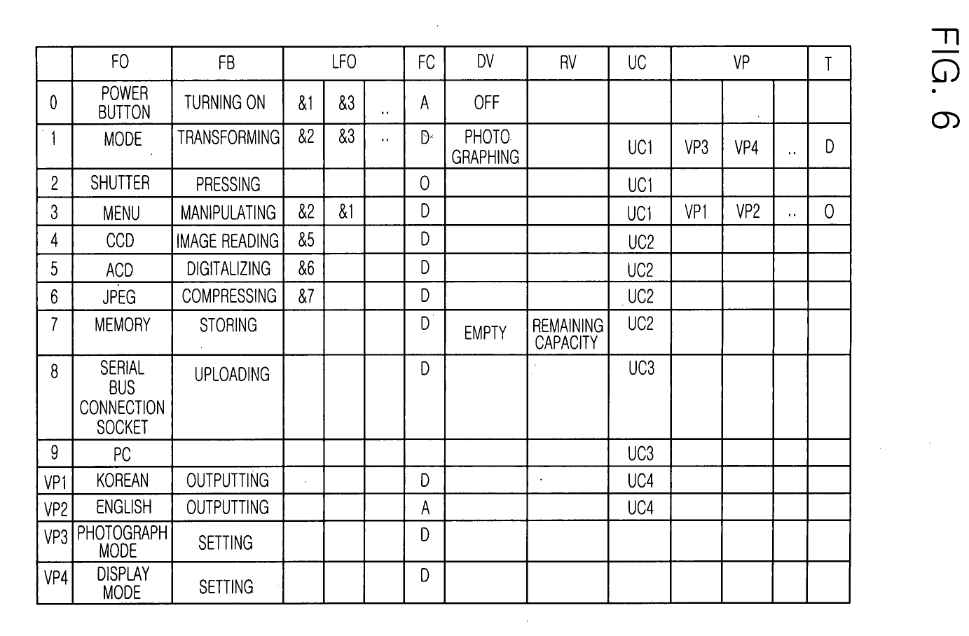

The priority graph editor 404 identifies the dependency graph, which is created through the repetitive refining by the dependency graph modeler, at each of execution paths to express the identified dependency graph by using the table-formatted priority graph. In FIG. 6, the detailed items of the priority graph are respectively expressed as Feature Object (FO), Feature Behavior (FB), Linked Feature Object (LFO), Feature Category (FC), Default Value (DV), Reference Value (RV), Use Case name (UC), Variation Point (VP) and Type of variation point (T).

In the priority graph, each of the objects has an address value, and the address value of the feature object is used to express the next execution sequence in the linked feature object list. In case where the dependency between the feature object and the feature behavior has an alternative option, a possibility of extracting variability is increased, and the variation point is determined on the basis of meaningful information, which is determined by product analyzing participants.

The test path identifier 405 identifies the execution path depending on the execution flow to a place, which is indicated by the feature object address of the linked feature object at each of feature objects of the priority graph editor 204. A worst case is a case in which the identified execution path is most long, and a best case is a case in which the identified execution path is most short. However, in case where the Feature Category (FC) does not refer to an arbitrary alternative edge expressed as “0” in number of the edge, the concise execution path can be easily obtained.

The graphic information processors 406 changes information, which is expressed using the dependency graph and the priority graph, into an expression format such as a graph or a table and visually show the change information.

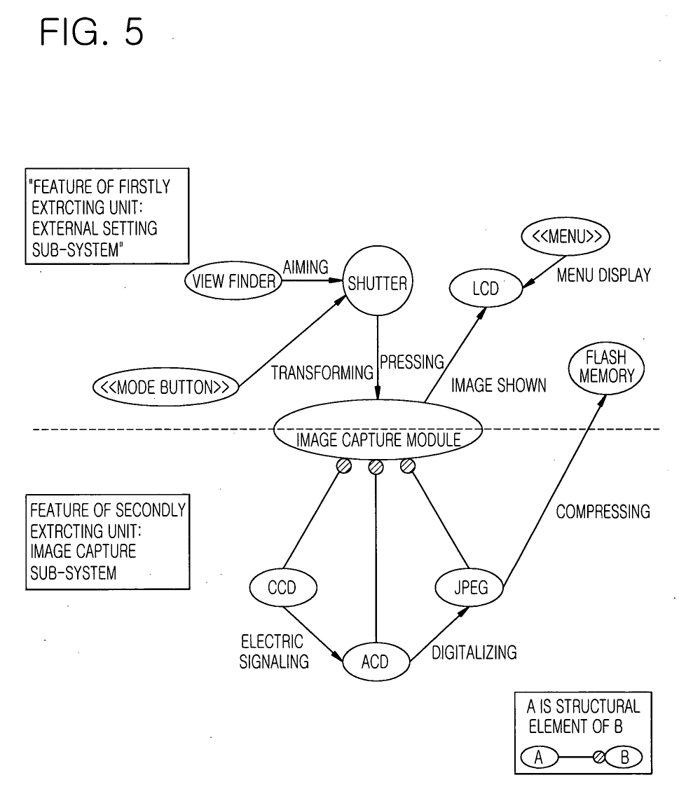

FIG. 5 illustrates an example of the dependency graph in case where the image is captured using the digital camera.

Referring to FIG. 5, the dependency graph is divided into upper and lower portions on the basis of a middle dotted line. The upper portion of the graph expresses a feature, which is extracted from the use case scenario, as a firstly extracted feature. The lower portion of the graph is required for the execution of the firstly extracted function of the sub system, and represents a secondly extracted feature, that is the reinforced feature from the firstly extracted one, by refining the dependency graph. The firstly extracted “Image Capture Module” is separated into core three feature objects, and newly identified feature objects represent information, which is modeled by complementing the dependency graph with the feature behavior. The feature objects are denoted by “<<“and “>>”. For example, the feature objects are represented in the format of “(<<mode button>>, <<menu>>)” to indicate a case where the variability exists when the feature behavior of the feature object is considered.

FIG. 6 illustrates an example of the priority graph using a view of the table format. Items constituting the priority graph are denoted as FO, FB, LFO, FC, DV, RV, UC, VP, and T.

As the items, there are provided the Feature Object (FO), the Feature Behavior (FB), the Linked Feature Object (LFO), the Feature Category (FC), the Default Value (DV), the Reference Value (RV), the Use Case name (UC), the Variation Point (VP), and the Type of variation point (T).

The numerals “0” to “9” of a vertical side denote information on an address at which the feature object is stored, and “VP1” to “VP4” symbolize and represent information on an address at which the variation point is stored. The address information is represented together with an address denotation of “&” at the LFO. The values of the FC and the T are denoted as “A” (Alternative: selecting one of two), “D” (Default: essential), and “0” (Optional: alternative execution). “UC1” to “UC4” of the UC expressively represent the use case name. “VPl” to “VP4” of the VP represents the variation point included in the feature object.

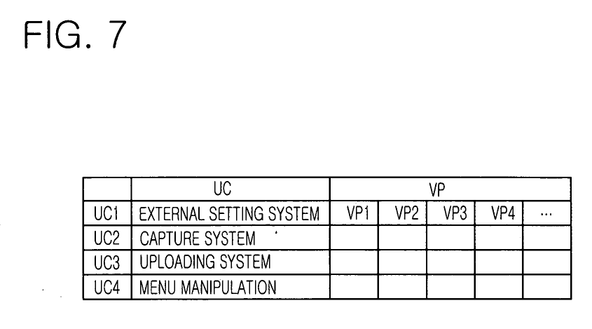

FIG. 7 illustrates an example of a use case-variability definition graph using the view of the table format.

The use case-variability definition graph is expressed in a graph structure including a variation point list provided from the use case. Here, the UC denotes the use case name, and the T denotes the type of the variation point.

As described above, the present invention identifies the object and behavior information, which is a unit of expressing the function of the system in the requirements, based on the product line, and analyzes the meaning and the execution operation by using the graph. The information expression based on the analyzed graph supports to examine the meaning and the execution operation, and calculates the test path and a complexity of execution at each of the paths.

As described above, in the inventive apparatus and method for analyzing the functionality and the test path of the product line using the priority graph, when the function of the system is designed and embodied in the text-formatted use case scenario, the core object and behavior is identified and the execution sequence of the behavior is expressed by using information based on the expressive and examinable graph. Further, the upper-level requirements of the text or context diagram format can be decomposed into a level of allowing the examination of a series of behavior execution sequences and states, so that the requirements necessary for the design and the embodiment of the system can be developed and the test path necessary for planning the test can be identified.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for analyzing functionality and test paths of product line using a priority graph, the apparatus comprising:
a parser for analyzing a use case scenario expressed in a text format, to separate a word from the analyzed use case scenario in a unit of word;
an object/behavior identifier for extracting core noun and verb from the separated word, to identify the extracted noun and verb as a feature object name and a feature behavior name;
a dependency graph modeler for supporting to model an execution flow of a function, which is expressed in the use case scenario using the feature object name and the feature behavior name;
a priority graph editor for supporting to analyze and express linked feature objects, a feature category, a default value, a reference value, a use case name, variation points which should be supported and a type of the variation point, for a next execution, at each of feature objects identified by repetitively refining a meaning information of a dependency graph;
a test path identifier for identifying test paths to examine requirements and plan a test from information expressed in a priority graph; and
a graphic information processor for visually changing and showing analysis information of the dependency graph and the priority graph.

2. A method for analyzing functionality and test paths of product line using a priority graph, the method comprising:
a step of describing an upper-level business process in a text format to change the described business process into a use case scenario specification;
a step of separating a noun and a verb in a unit of sentence from the text-formatted use case scenario specification;
a step of extracting essential noun and verb for the execution of a function, which is expressed in a use case scenario;
a dependency graph modeling step of modeling a feature object name and a feature behavior name being inherent attributes, as a node and an edge, on the basis of a function execution dependency specified in the use case scenario;
a dependency graph refining step of analyzing while refining additional information such as a linked feature object list, a category of a feature object, a default value, a reference value, a use case name, a supporting variation point list and a type of variation point, at a function execution path by using a dependency graph;
a priority graph-modeling step of expressing the analysis information using the priority graph;
a priority graph refining step of checking and refining a path flow in the priority graph;
a visual information processing step of changing an information expression method of the analyzed priority graph and visually showing the changed priority graph;
a step of editing a requirements analysis as a work product when the editing is requested;
a step of identifying a path necessary for the test in the priority graph; and
a step of editing a test plan when the editing is requested.

3. The method of claim 2, wherein in the dependency graph, the feature object name specified in the use case scenario is expressed as a node, and the feature object name specified in the use case scenario is expressed as a labeled edge.

4. The method of claim 2, wherein a variation point list for each use case, which is analyzed in the priority graph is expressed as index information on the priority graph, by using a use-case variation point graph.

5. The method of claim 2, wherein the priority graph is expressed using a feature object, a linked feature object list, a feature category, a default value, a reference value, a use case name, a variation point list, and a type of variation point.

6. The method of claim 2, wherein the dependency graph and the priority graph are processed and shown using a visual expression such as a graph and a table.

7. The method of claim 2, wherein on the basis of information expression of the priority graph, requirements are examined and a test path is identified for a testing plan.

8. The method of claim 2, wherein test requirements are inputted to analyze a best test case and a worst test case in the identified test path.
